(19) United States
(12) Patent Application Publication
(10) Pub. No.: US 2026/0252554 A1
(43) Pub. Date: Aug. 27, 2026

(54) SYSTEMS AND METHODS FOR UPDATING A DATABASE

(71) Applicant: Truist Bank, Charlotte, NC (US)

(72) Inventors: Vinod Parappillil Janardhanan Menon, Cary, NC (US); Ganesh Babu, High Point, NC (US)

(73) Assignee: Truist Bank, Charlotte, NC (US)

(21) Appl. No.: 19/062,557

(22) Filed: Feb. 25, 2025

(51) Int. Cl. G06F 16/23; G06Q 40/03

(52) U.S. Cl. CPC G06F 16/2386; G06Q 40/03

(57) ABSTRACT

A computer-implemented method for updating a database includes: receiving real-time or near real-time data; passing the real-time data through an extract, transform, load process; executing transaction matching logic on the real-time data to generate matched data; entering the substance of a record change based on the matched data into a first database; performing a backend process converting the record change to a batch process; and executing a batch update of a second database.

### FIELD OF THE INVENTION

This invention relates generally to the field of database management, and more particularly embodiments of the invention relate to middleware interfaces for databases.

### BACKGROUND OF THE INVENTION

This concept relates to handling updates for databases, in particular databases that require updating through batch processes. This is particularly relevant to the financial industry, where financial transaction data is transmitted over networks on a real-time or near real-time basis, but must be used to update datbases that can only be updated using batch processes, such as databases hosted on mainframe computers. One example is the administration of syndicated loans. A syndicated loan is a collection of bilateral loans between a borrower and several banks. In the prior art, these situations have required that the real-time data be manually entered into an appropriately-formatted change file and then handled by operations and technical teams. This increases the cost, complexity, and computer resources required for loan servicing.

Shortcomings of the prior art are overcome and additional advantages are provided through the provision of a computer-implemented method for updating a database, including: receiving real-time or near real-time data; passing the real-time data through an extract, transform, load process; executing transaction matching logic on the real-time data to generate matched data; entering the substance of a record change based on the matched data into a first database; performing a backend process converting the record change to a batch process; and executing a batch update of a second database.

According to some embodiments, the transition matching logic, the record change, and the back end process are performed on one or more cloud-hosted computer servers.

According to some embodiments, the real-time or near real-time data is tokenized before being transferred to the one or more cloud-hosted computer servers.

According to some embodiments, the real-time or near real-time data is de-tokenized before being transferred to the second database.

According to some embodiments, the transaction matching logic includes: receiving data formatted as a plurality of data fields relating to a transaction, wherein a data field required by the second database is missing; matching the received data fields to corresponding data fields in records within the second database, according to predetermined criteria; based on the matching, adding the missing field to the received data; and storing the data with the added field as a reformatted record.

According to some embodiments, the predetermined criteria includes matching of a minimum number of fields in a given record.

According to some embodiments, the predetermined criteria includes matching of a primary priority field.

According to some embodiments, the real-time or near real-time data is received at random intervals, and the batch update is performed at scheduled intervals.

According to some embodiments, the scheduled interval is once per day.

According to some embodiments, the real-time or near real-time data is received from a third party over a data network.

According to some embodiments, the real-time or near real-time data represents a financial transaction.

According to some embodiments, the financial transaction is a loan payment.

According to some embodiments, the second database is stored on a mainframe computer.

According to some embodiments, the real-time or near real-time data is received through an API.

According to some embodiments, the API is a part of a gateway which also includes a gateway ETL pipeline component, a gateway database, and a gateway backend process component.

According to some embodiments, the gateway is hosted on a cloud computing service.

According to some embodiments, the method further includes: receiving real-time or near real-time data from a client system, through a gateway client API; entering the substance of a record change based on the real-time or near real-time data into a first database; performing a backend process converting the record change to a batch process; and executing a batch update of a second database.

According to some embodiments, the method further includes: receiving real-time or near real-time data from a web application, through a gateway backend API; entering the substance of a record change based on the real-time or near real-time data into a first database; performing a backend process converting the record change to a batch process; and executing a batch update of a second database.

Additionally, disclosed herein is a computing system for updating a database, the system includeing: at least one processor; a communication interface communicatively coupled to the at least one processor; and a memory device storing executable code. When executed, the code causes the at least one processor to: receive real-time or near real-time data; pass the real-time or near real-time data through an extract, transform, load process; execute transaction matching logic on the real-time data to generate matched data; enter the substance of a record change based on the matched data into a first database; perform a backend process converting the record change to a batch process; and execute a batch update of a second database.

Also disclosed herein is a non-transitory computer-readable storage medium, the computer-readable storage medium including instructions that when executed by a processor, cause the processor to: receive real-time or near real-time data; pass the real-time or near real-time data through an extract, transform, load process; execute transaction matching logic on the real-time data to generate matched data; enter the substance of a record change based on the matched data into a first database; perform a backend process converting the record change to a batch process; and execute a batch update of a second database.

The features, functions, and advantages that have been described herein may be achieved independently in various embodiments of the present invention including computer-implemented methods, computer program products, and computing systems or may be combined in yet other embodiments, further details of which can be seen with reference to the following description and drawings.

### BRIEF DESCRIPTION OF THE SEVERAL VIEWS OF THE DRAWINGS

One or more aspects are particularly pointed out and distinctly claimed as examples in the claims at the conclusion of the specification. The foregoing as well as objects, features, and advantages of one or more aspects are apparent from the following detailed description taken in conjunction with the accompanying drawings in which:

FIG. 1 illustrates an enterprise system, and environment thereof for , in accordance with an embodiment of the present invention;

FIG. 2 is a diagram of a computing system including a gateway, connected to one or more clients, and one or more third-party data services;

FIG. 3 is a diagram illustrating an inbound file process for the gateway;

FIG. 4 is a flow chart of an internal batch process of a gateway;

FIG. 5 is a diagram showing a data field matching process; and

FIG. 6 is a diagram illustrating an outbound file process for the gateway.

### DETAILED DESCRIPTION

Aspects of the present invention and certain features, advantages, and details thereof are explained more fully below with reference to the non-limiting examples illustrated in the accompanying drawings. Descriptions of well-known processing techniques, systems, components, etc. are omitted so as to not unnecessarily obscure the invention in detail. It should be understood that the detailed description and the specific examples, while indicating aspects of the invention, are given by way of illustration only, and not by way of limitation. Various substitutions, modifications, additions, and/or arrangements, within the spirit and/or scope of the underlying inventive concepts will be apparent to those skilled in the art from this disclosure. Note further that numerous inventive aspects and features are disclosed herein, and unless inconsistent, each disclosed aspect or feature is combinable with any other disclosed aspect or feature as desired for a particular embodiment of the concepts disclosed herein.

Unless described or implied as exclusive alternatives, features throughout the drawings and descriptions should be taken as cumulative, such that features expressly associated with some particular embodiments can be combined with other embodiments.

While certain exemplary embodiments have been described and shown in the accompanying drawings, it is to be understood that such embodiments are merely illustrative of, and not restrictive on, the broad invention, and that this invention not be limited to the specific constructions and arrangements shown and described, since various other changes, combinations, omissions, modifications and substitutions, in addition to those set forth in the above paragraphs, are possible. Those skilled in the art will appreciate that various adaptations, modifications, and combinations of the herein described embodiments can be configured without departing from the scope and spirit of the invention. Therefore, it is to be understood that, within the scope of the included claims, the invention may be practiced other than as specifically described herein.

Additionally, illustrative embodiments are described below using specific code, designs, architectures, protocols, layouts, schematics, or tools only as examples, and not by way of limitation. Furthermore, the illustrative embodiments are described in certain instances using particular software, tools, or data processing environments only as example for clarity of description. The illustrative embodiments can be used in conjunction with other comparable or similarly purposed structures, systems, applications, or architectures. One or more aspects of an illustrative embodiment can be implemented in hardware, software, or a combination thereof.

As understood by one skilled in the art, program code, as referred to in this application, can include both software and hardware. For example, program code in certain embodiments of the present invention can include fixed function hardware, while other embodiments can utilize a software-based implementation of the functionality described. Certain embodiments combine both types of program code.

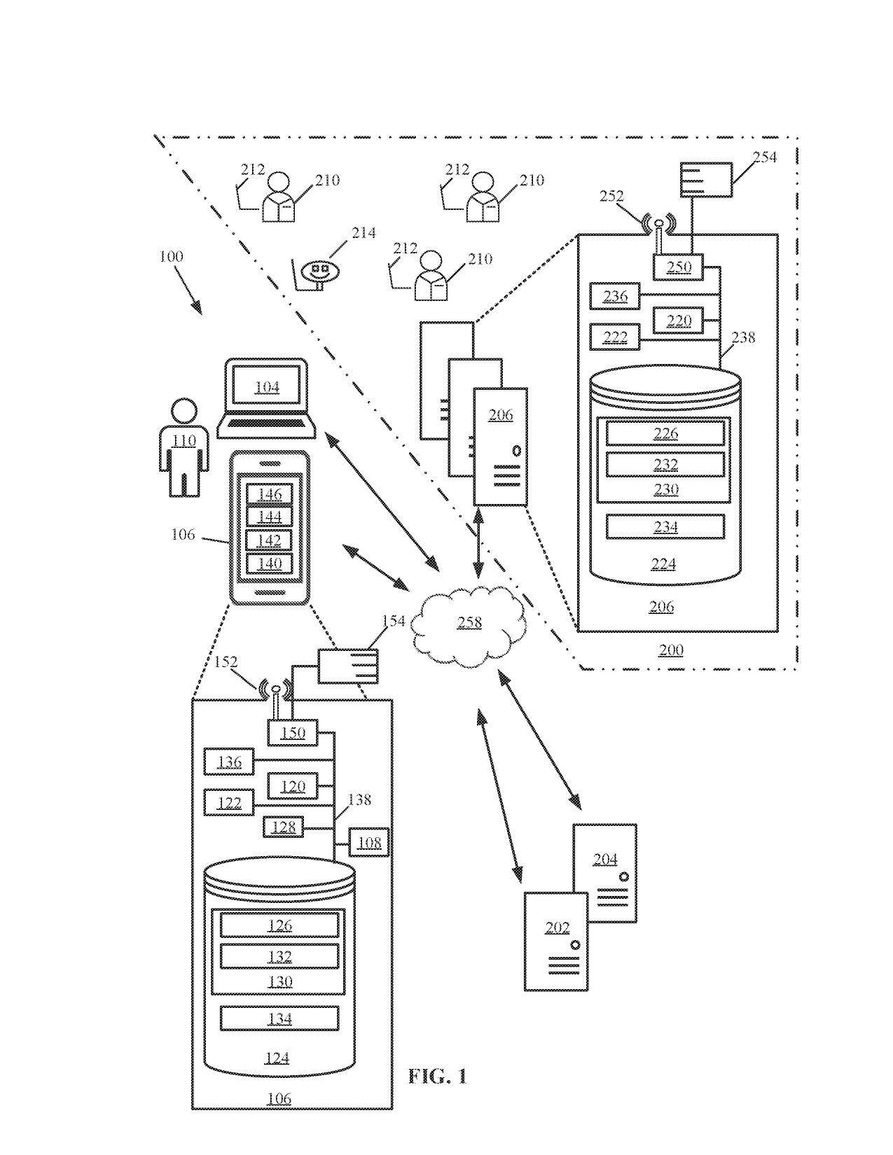

FIG. 1 illustrates a system 100 and environment thereof, according to at least one embodiment, by which a user 110 benefits through use of services and products of an enterprise system 200. The environment may include, for example, a distributed cloud computing environment (private cloud, public cloud, community cloud, and/or hybrid cloud), an on-premise environment, fog computing environment, and/or an edge computing environment. The user 110 accesses services and products by use of one or more user devices, illustrated in separate examples as a computing device 104 and a mobile device 106, which may be, as non-limiting examples, a smart phone, a portable digital assistant (PDA), a pager, a mobile television, a gaming device, a laptop computer, a camera, a video recorder, an audio/video player, radio, a GPS device, or any combination of the aforementioned, or other portable device with processing and communication capabilities. In the illustrated example, the mobile device 106 is illustrated in FIG. 1 as having exemplary elements, the below descriptions of which apply as well to the computing device 104, which can be, as non-limiting examples, a desktop computer, a laptop computer, or other user-accessible computing device.

Furthermore, the user device, referring to either or both of the computing device 104 and the mobile device 106, may be or include a workstation, a server, or any other suitable device, including a set of servers, a cloud-based application or system, or any other suitable system, adapted to execute, for example any suitable operating system, including Linux, UNIX, Windows, macOS, iOS, Android and any other known operating system used on personal computers, central computing systems, phones, and other devices.

The user 110 can be an individual, a group, or any entity in possession of or having access to the user device, referring to either or both of the mobile device 104 and computing device 106, which may be personal or public items. Although the user 110 may be singly represented in some drawings, at least in some embodiments according to these descriptions the user 110 is one of many such that a market or community of users, consumers, customers, business entities, government entities, clubs, and groups of any size are all within the scope of these descriptions.

The user device, as illustrated with reference to the mobile device 106, includes components such as, at least one of each of a processing device 120, and a memory device 122 for processing use, such as random access memory (RAM), and read-only memory (ROM). The illustrated mobile device 106 further includes a storage device 124 including at least one of a non-transitory storage medium, such as a microdrive, for long-term, intermediate-term, and short-term storage of computer-readable instructions 126 for execution by the processing device 120. For example, the instructions 126 can include instructions for an operating system and various applications or programs 130, of which the application 132 is represented as a particular example. The storage device 124 can store various other data items 134, which can include, as non-limiting examples, cached data, user files such as those for pictures, audio and/or video recordings, files downloaded or received from other devices, and other data items preferred by the user or required or related to any or all of the applications or programs 130.

The memory device 122 is operatively coupled to the processing device 120. As used herein, memory includes any computer readable medium to store data, code, or other information. The memory device 122 may include volatile memory, such as volatile Random Access Memory (RAM) including a cache area for the temporary storage of data. The memory device 122 may also include non-volatile memory, which can be embedded and/or may be removable. The non-volatile memory can additionally or alternatively include an electrically erasable programmable read-only memory (EEPROM), flash memory or the like.

According to various embodiments, the memory device 122 and storage device 124 may be combined into a single storage medium. The memory device 122 and storage device 124 can store any of a number of applications which comprise computer-executable instructions and code executed by the processing device 120 to implement the functions of the mobile device 106 described herein. For example, the memory device 122 may include such applications as a conventional web browser application and/or a mobile P2P payment system client application. These applications also typically provide a graphical user interface (GUI) on the display 140 that allows the user 110 to communicate with the mobile device 106, and, for example a mobile banking system, and/or other devices or systems. In one embodiment, when the user 110 decides to enroll in a mobile banking program, the user 110 downloads or otherwise obtains the mobile banking system client application from a mobile banking system, for example enterprise system 200, or from a distinct application server. In other embodiments, the user 110 interacts with a mobile banking system via a web browser application in addition to, or instead of, the mobile P2P payment system client application.

The processing device 120, and other processors described herein, generally include circuitry for implementing communication and/or logic functions of the mobile device 106. For example, the processing device 120 may include a digital signal processor, a microprocessor, and various analog to digital converters, digital to analog converters, and/or other support circuits. Control and signal processing functions of the mobile device 106 are allocated between these devices according to their respective capabilities. The processing device 120 thus may also include the functionality to encode and interleave messages and data prior to modulation and transmission. The processing device 120 can additionally include an internal data modem. Further, the processing device 120 may include functionality to operate one or more software programs, which may be stored in the memory device 122, or in the storage device 124. For example, the processing device 120 may be capable of operating a connectivity program, such as a web browser application. The web browser application may then allow the mobile device 106 to transmit and receive web content, such as, for example, location-based content and/or other web page content, according to a Wireless Application Protocol (WAP), Hypertext Transfer Protocol (HTTP), and/or the like.

The memory device 122 and storage device 124 can each also store any of a number of pieces of information, and data, used by the user device and the applications and devices that facilitate functions of the user device, or are in communication with the user device, to implement the functions described herein and others not expressly described. For example, the storage device may include such data as user authentication information, etc.

The processing device 120, in various examples, can operatively perform calculations, can process instructions for execution, and can manipulate information. The processing device 120 can execute machine-executable instructions stored in the storage device 124 and/or memory device 122 to thereby perform methods and functions as described or implied herein, for example by one or more corresponding flow charts expressly provided or implied as would be understood by one of ordinary skill in the art to which the subject matters of these descriptions pertain. The processing device 120 can be or can include, as non-limiting examples, a central processing unit (CPU), a microprocessor, a graphics processing unit (GPU), a microcontroller, an application-specific integrated circuit (ASIC), a programmable logic device (PLD), a digital signal processor (DSP), a field programmable gate array (FPGA), a state machine, a controller, gated or transistor logic, discrete physical hardware components, and combinations thereof. In some embodiments, particular portions or steps of methods and functions described herein are performed in whole or in part by way of the processing device 120, while in other embodiments methods and functions described herein include cloud-based computing in whole or in part such that the processing device 120 facilitates local operations including, as non-limiting examples, communication, data transfer, and user inputs and outputs such as receiving commands from and providing displays to the user.

The mobile device 106, as illustrated, includes an input and output system 136, referring to, including, or operatively coupled with, one or more user input devices and/or one or more user output devices, which are operatively coupled to the processing device 120. The input and output system 136 may include input/output circuitry that may operatively convert analog signals and other signals into digital data, or may convert digital data to another type of signal. For example, the input/output circuitry may receive and convert physical contact inputs, physical movements, or auditory signals (e.g., which may be used to authenticate a user) to digital data. Once converted, the digital data may be provided to the processing device 120. The input and output system 136 may also include a display 140 (e.g., a liquid crystal display (LCD), light emitting diode (LED) display, or the like), which can be, as a non-limiting example, a presence-sensitive input screen (e.g., touch screen or the like) of the mobile device 106, which serves both as an output device, by providing graphical and text indicia and presentations for viewing by one or more user 110, and as an input device, by providing virtual buttons, selectable options, a virtual keyboard, and other indicia that, when touched, control the mobile device 106 by user action. The user output devices include a speaker 144 or other audio device. The user input devices, which allow the mobile device 106 to receive data and actions such as button manipulations and touches from a user such as the user 110, may include any of a number of devices allowing the mobile device 106 to receive data from a user, such as a keypad, keyboard, touch-screen, touchpad, microphone 142, mouse, joystick, other pointer device, button, soft key, infrared sensor, and/or other input device(s). The input and output system 136 may also include a camera 146, such as a digital camera.

Further non-limiting examples of input devices and/or output devices include, one or more of each, any, and all of a wireless or wired keyboard, a mouse, a touchpad, a button, a switch, a light, an LED, a buzzer, a bell, a printer and/or other user input devices and output devices for use by or communication with the user 110 in accessing, using, and controlling, in whole or in part, the user device, referring to either or both of the computing device 104 and a mobile device 106. Inputs by one or more user 110 can thus be made via voice, text or graphical indicia selections. For example, such inputs in some examples correspond to user-side actions and communications seeking services and products of the enterprise system 200, and at least some outputs in such examples correspond to data representing enterprise-side actions and communications in two-way communications between a user 110 and an enterprise system 200.

The input and output system 136 may also be configured to obtain and process various forms of authentication via an authentication system to obtain authentication information of a user 110. Various authentication systems may include, according to various embodiments, a recognition system that detects biometric features or attributes of a user such as, for example fingerprint recognition systems and the like (hand print recognition systems, palm print recognition systems, etc.), iris recognition and the like used to authenticate a user based on features of the user’s eyes, facial recognition systems based on facial features of the user, DNA-based authentication, or any other suitable biometric attribute or information associated with a user. Additionally or alternatively, voice biometric systems may be used to authenticate a user using speech recognition associated with a word, phrase, tone, or other voice-related features of the user. Alternate authentication systems may include one or more systems to identify a user based on a visual or temporal pattern of inputs provided by the user. For instance, the user device may display, for example, selectable options, shapes, inputs, buttons, numeric representations, etc. that must be selected in a pre-determined specified order or according to a specific pattern. Other authentication processes are also contemplated herein including, for example, email authentication, password protected authentication, device verification of saved devices, code-generated authentication, text message authentication, phone call authentication, etc. The user device may enable users to input any number or combination of authentication systems.

The user device, referring to either or both of the computing device 104 and the mobile device 106 may also include a positioning device 108, which can be for example a global positioning system device (GPS) configured to be used by a positioning system to determine a location of the computing device 104 or mobile device 106. For example, the positioning system device 108 may include a GPS transceiver. In some embodiments, the positioning system device 108 includes an antenna, transmitter, and receiver. For example, in one embodiment, triangulation of cellular signals may be used to identify the approximate location of the mobile device 106. In other embodiments, the positioning device 108 includes a proximity sensor or transmitter, such as an RFID tag, that can sense or be sensed by devices known to be located proximate a merchant or other location to determine that the consumer mobile device 106 is located proximate these known devices.

In the illustrated example, a system intraconnect 138, connects, for example electrically, the various described, illustrated, and implied components of the mobile device 106. The intraconnect 138, in various non-limiting examples, can include or represent, a system bus, a high-speed interface connecting the processing device 120 to the memory device 122, individual electrical connections among the components, and electrical conductive traces on a motherboard common to some or all of the above-described components of the user device (referring to either or both of the computing device 104 and the mobile device 106). As discussed herein, the system intraconnect 138 may operatively couple various components with one another, or in other words, electrically connects those components, either directly or indirectly – by way of intermediate component(s) – with one another.

The user device, referring to either or both of the computing device 104 and the mobile device 106, with particular reference to the mobile device 106 for illustration purposes, includes a communication interface 150, by which the mobile device 106 communicates and conducts transactions with other devices and systems. The communication interface 150 may include digital signal processing circuitry and may provide two-way communications and data exchanges, for example wirelessly via wireless communication device 152, and for an additional or alternative example, via wired or docked communication by mechanical electrically conductive connector 154. Communications may be conducted via various modes or protocols, of which GSM voice calls, SMS, EMS, MMS messaging, TDMA, CDMA, PDC, WCDMA, CDMA2000, and GPRS, are all non-limiting and non-exclusive examples. Thus, communications can be conducted, for example, via the wireless communication device 152, which can be or include a radio-frequency transceiver, a Bluetooth device, Wi-Fi device, a Near-field communication device, and other transceivers. In addition, GPS (Global Positioning System) may be included for navigation and location-related data exchanges, ingoing and/or outgoing. Communications may also or alternatively be conducted via the connector 154 for wired connections such by USB, Ethernet, and other physically connected modes of data transfer.

The processing device 120 is configured to use the communication interface 150 as, for example, a network interface to communicate with one or more other devices on a network. In this regard, the communication interface 150 utilizes the wireless communication device 152 as an antenna operatively coupled to a transmitter and a receiver (together a “transceiver”) included with the communication interface 150. The processing device 120 is configured to provide signals to and receive signals from the transmitter and receiver, respectively. The signals may include signaling information in accordance with the air interface standard of the applicable cellular system of a wireless telephone network. In this regard, the mobile device 106 may be configured to operate with one or more air interface standards, communication protocols, modulation types, and access types. By way of illustration, the mobile device 106 may be configured to operate in accordance with any of a number of first, second, third, fourth, fifth-generation communication protocols and/or the like. For example, the mobile device 106 may be configured to operate in accordance with second-generation (2G) wireless communication protocols IS-136 (time division multiple access (TDMA)), GSM (global system for mobile communication), and/or IS-95 (code division multiple access (CDMA)), or with third-generation (3G) wireless communication protocols, such as Universal Mobile Telecommunications System (UMTS), CDMA2000, wideband CDMA (WCDMA) and/or time division-synchronous CDMA (TD-SCDMA), with fourth-generation (4G) wireless communication protocols such as Long-Term Evolution (LTE), fifth-generation (5G) wireless communication protocols, Bluetooth Low Energy (BLE) communication protocols such as Bluetooth 5.0, ultra-wideband (UWB) communication protocols, and/or the like. The mobile device 106 may also be configured to operate in accordance with non-cellular communication mechanisms, such as via a wireless local area network (WLAN) or other communication/data networks.

The communication interface 150 may also include a payment network interface. The payment network interface may include software, such as encryption software, and hardware, such as a modem, for communicating information to and/or from one or more devices on a network. For example, the mobile device 106 may be configured so that it can be used as a credit or debit card by, for example, wirelessly communicating account numbers or other authentication information to a terminal of the network. Such communication could be performed via transmission over a wireless communication protocol such as the Near-field communication protocol.

The mobile device 106 further includes a power source 128, such as a battery, for powering various circuits and other devices that are used to operate the mobile device 106. Embodiments of the mobile device 106 may also include a clock or other timer configured to determine and, in some cases, communicate actual or relative time to the processing device 120 or one or more other devices. For further example, the clock may facilitate timestamping transmissions, receptions, and other data for security, authentication, logging, polling, data expiry, and forensic purposes.

System 100 as illustrated diagrammatically represents at least one example of a possible implementation, where alternatives, additions, and modifications are possible for performing some or all of the described methods, operations and functions. Although shown separately, in some embodiments, two or more systems, servers, or illustrated components may utilized. In some implementations, the functions of one or more systems, servers, or illustrated components may be provided by a single system or server. In some embodiments, the functions of one illustrated system or server may be provided by multiple systems, servers, or computing devices, including those physically located at a central facility, those logically local, and those located as remote with respect to each other.

The enterprise system 200 can offer any number or type of services and products to one or more users 110. In some examples, an enterprise system 200 offers products. In some examples, an enterprise system 200 offers services. Use of “service(s)” or “product(s)” thus relates to either or both in these descriptions. With regard, for example, to online information and financial services, “service” and “product” are sometimes termed interchangeably. In non-limiting examples, services and products include retail services and products, information services and products, custom services and products, predefined or pre-offered services and products, consulting services and products, advising services and products, forecasting services and products, internet products and services, social media, and financial services and products, which may include, in non-limiting examples, services and products relating to banking, checking, savings, investments, credit cards, automatic-teller machines, debit cards, loans, mortgages, personal accounts, business accounts, account management, credit reporting, credit requests, and credit scores.

To provide access to, or information regarding, some or all the services and products of the enterprise system 200, automated assistance may be provided by the enterprise system 200. For example, automated access to user accounts and replies to inquiries may be provided by enterprise-side automated voice, text, and graphical display communications and interactions. In at least some examples, any number of human agents 210, can be employed, utilized, authorized or referred by the enterprise system 200. Such human agents 210 can be, as non-limiting examples, point of sale or point of service (POS) representatives, online customer service assistants available to users 110, advisors, managers, sales team members, and referral agents ready to route user requests and communications to preferred or particular other agents, human or virtual.

Human agents 210 may utilize agent devices 212 to serve users in their interactions to communicate and take action. The agent devices 212 can be, as non-limiting examples, computing devices, kiosks, terminals, smart devices such as phones, and devices and tools at customer service counters and windows at POS locations. In at least one example, the diagrammatic representation of the components of the user device 106 in FIG. 1 applies as well to one or both of the computing device 104 and the agent devices 212.

Agent devices 212 individually or collectively include input devices and output devices, including, as non-limiting examples, a touch screen, which serves both as an output device by providing graphical and text indicia and presentations for viewing by one or more agent 210, and as an input device by providing virtual buttons, selectable options, a virtual keyboard, and other indicia that, when touched or activated, control or prompt the agent device 212 by action of the attendant agent 210. Further non-limiting examples include, one or more of each, any, and all of a keyboard, a mouse, a touchpad, a joystick, a button, a switch, a light, an LED, a microphone serving as input device for example for voice input by a human agent 210, a speaker serving as an output device, a camera serving as an input device, a buzzer, a bell, a printer and/or other user input devices and output devices for use by or communication with a human agent 210 in accessing, using, and controlling, in whole or in part, the agent device 212.

Inputs by one or more human agents 210 can thus be made via voice, text or graphical indicia selections. For example, some inputs received by an agent device 212 in some examples correspond to, control, or prompt enterprise-side actions and communications offering services and products of the enterprise system 200, information thereof, or access thereto. At least some outputs by an agent device 212 in some examples correspond to, or are prompted by, user-side actions and communications in two-way communications between a user 110 and an enterprise-side human agent 210.

From a user perspective experience, an interaction in some examples within the scope of these descriptions begins with direct or first access to one or more human agents 210 in person, by phone, or online for example via a chat session or website function or feature. In other examples, a user is first assisted by a virtual agent 214 of the enterprise system 200, which may satisfy user requests or prompts by voice, text, or online functions, and may refer users to one or more human agents 210 once preliminary determinations or conditions are made or met.

A computing system 206 of the enterprise system 200 may include components such as, at least one of each of a processing device 220, and a memory device 222 for processing use, such as random access memory (RAM), and read-only memory (ROM). The illustrated computing system 206 further includes a storage device 224 including at least one non-transitory storage medium, such as a microdrive, for long-term, intermediate-term, and short-term storage of computer-readable instructions 226 for execution by the processing device 220. For example, the instructions 226 can include instructions for an operating system and various applications or programs 230, of which the application 232 is represented as a particular example. The storage device 224 can store various other data 234, which can include, as non-limiting examples, cached data, and files such as those for user accounts, user profiles, account balances, and transaction histories, files downloaded or received from other devices, and other data items preferred by the user or required or related to any or all of the applications or programs 230.

The computing system 206, in the illustrated example, includes an input/output system 236, referring to, including, or operatively coupled with input devices and output devices such as, in a non-limiting example, agent devices 212, which have both input and output capabilities.

In the illustrated example, a system intraconnect 238 electrically connects the various above-described components of the computing system 206. In some cases, the intraconnect 238 operatively couples components to one another, which indicates that the components may be directly or indirectly connected, such as by way of one or more intermediate components. The intraconnect 238, in various non-limiting examples, can include or represent, a system bus, a high-speed interface connecting the processing device 220 to the memory device 222, individual electrical connections among the components, and electrical conductive traces on a motherboard common to some or all of the above-described components of the user device.

The computing system 206, in the illustrated example, includes a communication interface 250, by which the computing system 206 communicates and conducts transactions with other devices and systems. The communication interface 250 may include digital signal processing circuitry and may provide two-way communications and data exchanges, for example wirelessly via wireless device 252, and for an additional or alternative example, via wired or docked communication by mechanical electrically conductive connector 254. Communications may be conducted via various modes or protocols, of which GSM voice calls, SMS, EMS, MMS messaging, TDMA, CDMA, PDC, WCDMA, CDMA2000, and GPRS, are all non-limiting and non-exclusive examples. Thus, communications can be conducted, for example, via the wireless device 252, which can be or include a radio-frequency transceiver, a Bluetooth device, Wi-Fi device, Near-field communication device, and other transceivers. In addition, GPS (Global Positioning System) may be included for navigation and location-related data exchanges, ingoing and/or outgoing. Communications may also or alternatively be conducted via the connector 254 for wired connections such as by USB, Ethernet, and other physically connected modes of data transfer.

The processing device 220, in various examples, can operatively perform calculations, can process instructions for execution, and can manipulate information. The processing device 220 can execute machine-executable instructions stored in the storage device 224 and/or memory device 222 to thereby perform methods and functions as described or implied herein, for example by one or more corresponding flow charts expressly provided or implied as would be understood by one of ordinary skill in the art to which the subjects matters of these descriptions pertain. The processing device 220 can be or can include, as non-limiting examples, a central processing unit (CPU), a microprocessor, a graphics processing unit (GPU), a microcontroller, an application-specific integrated circuit (ASIC), a programmable logic device (PLD), a digital signal processor (DSP), a field programmable gate array (FPGA), a state machine, a controller, gated or transistor logic, discrete physical hardware components, and combinations thereof.

Furthermore, the computing system 206, may be or include a workstation, a server, or any other suitable device, including a set of servers, a cloud-based application or system, or any other suitable system, adapted to execute, for example any suitable operating system, including Linux, UNIX, Windows, macOS, iOS, Android, and any known other operating system used on personal computer, central computing systems, phones, and other devices.

The user devices, referring to either or both of the computing device 104 and mobile device 106, the agent devices 212, and the enterprise computing system 206, which may be one or any number centrally located or distributed, are in communication through one or more networks, referenced as network 258 in FIG. 1.

Network 258 provides wireless or wired communications among the components of the system 100 and the environment thereof, including other devices local or remote to those illustrated, such as additional mobile devices, servers, and other devices communicatively coupled to network 258, including those not illustrated in FIG. 1. The network 258 is singly depicted for illustrative convenience, but may include more than one network without departing from the scope of these descriptions. In some embodiments, the network 258 may be or provide one or more cloud-based services or operations. The network 258 may be or include an enterprise or secured network, or may be implemented, at least in part, through one or more connections to the Internet. A portion of the network 258 may be a virtual private network (VPN) or an Intranet. The network 258 can include wired and wireless links, including, as non-limiting examples, 802.11a/b/g/n/ac, 802.20, WiMax, LTE, and/or any other wireless link. The network 258 may include any internal or external network, networks, sub-network, and combinations of such operable to implement communications between various computing components within and beyond the illustrated system 100. The network 258 may communicate, for example, Internet Protocol (IP) packets, Frame Relay frames, Asynchronous Transfer Mode (ATM) cells, voice, video, data, and other suitable information between network addresses. The network 258 may also include one or more local area networks (LANs), radio access networks (RANs), metropolitan area networks (MANs), wide area networks (WANs), all or a portion of the internet and/or any other communication system or systems at one or more locations.

The network 258 may incorporate a cloud platform/data center that support various service models including Platform as a Service (PaaS), Infrastructure-as-a-Service (IaaS), and Software-as-a-Service (SaaS). Such service models may provide, for example, a digital platform accessible to the user device (referring to either or both of the computing device 104 and the mobile device 106). Specifically, SaaS may provide a user with the capability to use applications running on a cloud infrastructure, where the applications are accessible via a thin client interface such as a web browser and the user is not permitted to manage or control the underlying cloud infrastructure (i.e., network, servers, operating systems, storage, or specific application capabilities that are not user-specific). PaaS also do not permit the user to manage or control the underlying cloud infrastructure, but this service may enable a user to deploy user-created or acquired applications onto the cloud infrastructure using programming languages and tools provided by the provider of the application. In contrast, IaaS provides a user the permission to provision processing, storage, networks, and other computing resources as well as run arbitrary software (e.g., operating systems and applications) thereby giving the user control over operating systems, storage, deployed applications, and potentially select networking components (e.g., host firewalls).

The network 258 may also incorporate various cloud-based deployment models including private cloud (i.e., an organization-based cloud managed by either the organization or third parties and hosted on-premises or off premises), public cloud (i.e., cloud-based infrastructure available to the general public that is owned by an organization that sells cloud services), community cloud (i.e., cloud-based infrastructure shared by several organizations and manages by the organizations or third parties and hosted on-premises or off premises), and/or hybrid cloud (i.e., composed of two or more clouds e.g., private community, and/or public).

Two external systems 202 and 204 are expressly illustrated in FIG. 1, representing any number and variety of data sources, users, consumers, customers, business entities, banking systems, government entities, clubs, and groups of any size are all within the scope of the descriptions. In at least one example, the external systems 202 and 204 represent automatic teller machines (ATMs) utilized by the enterprise system 200 in serving users 110. In another example, the external systems 202 and 204 represent payment clearinghouse or payment rail systems for processing payment transactions, and in another example, the external systems 202 and 204 represent third party systems such as merchant systems configured to interact with the user device 106 during transactions and also configured to interact with the enterprise system 200 in back-end transactions clearing processes.

In certain embodiments, one or more of the systems such as the user device (referring to either or both of the computing device 104 and the mobile device 106), the enterprise system 200, and/or the external systems 202 and 204 are, include, or utilize virtual resources. In some cases, such virtual resources are considered cloud resources or virtual machines. The cloud computing configuration may provide an infrastructure that includes a network of interconnected nodes and provides stateless, low coupling, modularity, and semantic interoperability. Such interconnected nodes may incorporate a computer system that includes one or more processors, a memory, and a bus that couples various system components (e.g., the memory) to the processor. Such virtual resources may be available for shared use among multiple distinct resource consumers and in certain implementations, virtual resources do not necessarily correspond to one or more specific pieces of hardware, but rather to a collection of pieces of hardware operatively coupled within a cloud computing configuration so that the resources may be shared as needed.

Aspects of the computing system 206 may provide services through their connections to one or more third parties or external services. Certain ones of the connections may transmit and receive data in real-time or near real-time, while other connections may require batch processing. For example, some services may be hosted on mainframe computers. In order to streamline operation of the computing system 206, it may include or be operated in conjunction with a gateway which forms a middleware component between the real-time or near real-time entities and the batch entities.

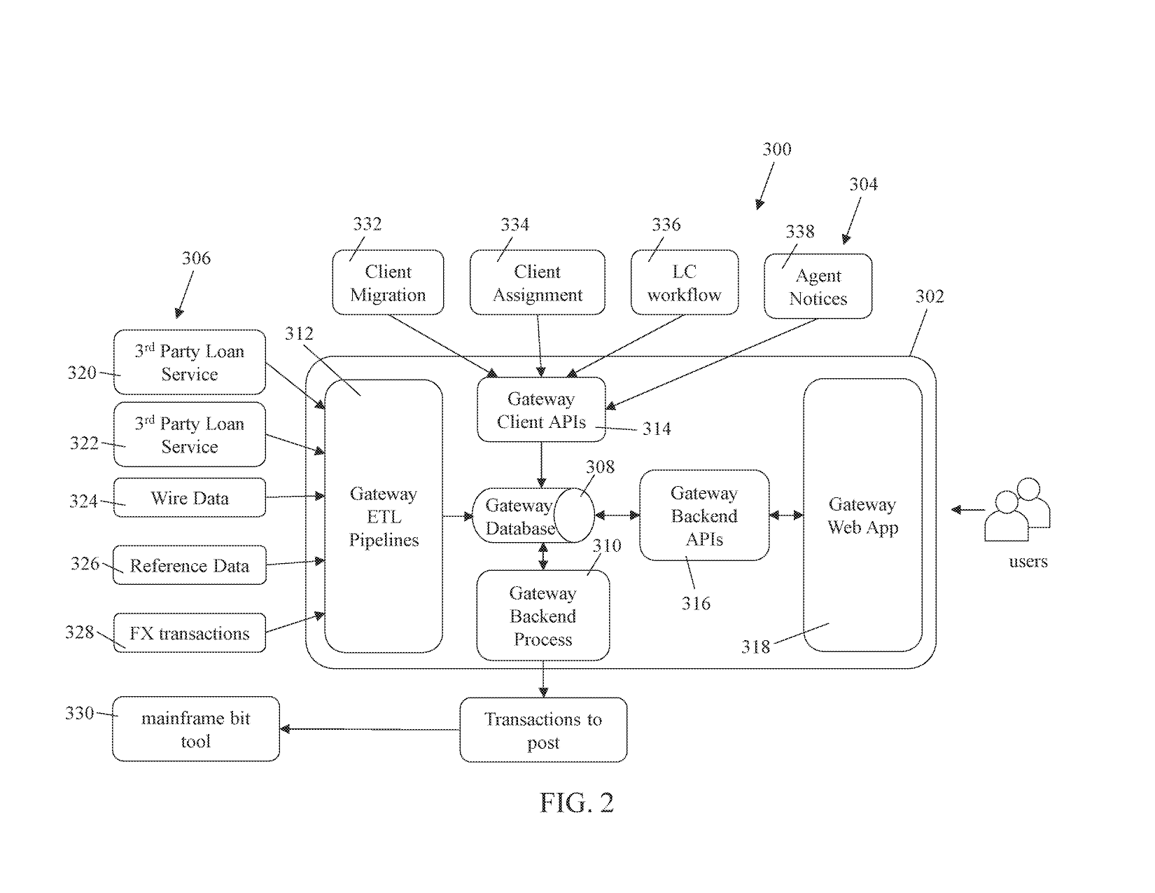

FIG. 2 illustrates a computing system 300 including a gateway 302, alternatively referred to as a "wholesale gateway". The gateway 302 is connected to one or more clients 304. The gateway is also connected to one or more third-party data services 306.

For descriptive purposes the gateway 302 may be considered to include several individual components or modules. Exemplary components include: a gateway database 308, a gateway backend process 310, a gateway extract-transform-load ("ETL") pipeline 312, client APIs 314, gateway backend application program interfaces ("APIs") 316, and a gateway web application ("web app") 318. The components or modules may be embodied by one or more general-purpose processors, custom-built processors, one or more general-purpose computers with specific software loaded thereon, or by one or more software programs software hosted on one or more remote computers.

The gateway 302 is connected in data communication with various entities over networks such as local area networks, wide area networks, or the Internet. As illustrated, the ETL pipeline 312 is in communication with a first third-party loan service 320, a second third-party loan service 322, a financial wire data service 324, a reference data service 326, and a foreign exchange service 328.

The gateway 302 is also connected in data communication with an external database 330 which is used as a repository and clearinghouse for significant data. In one example, the external database 330 may be hosted on a mainframe computer. A characteristic of the external database 330 is that record changes (e.g., additions, deletions, or edits) have to be performed through a batch process in which desired changes are submitted in a discrete file having a predefined format. This is an contrast to other types of databases, which may be accessed through real-time user interfaces such as graphical user interfaces.

The gateway 302 is also connected in data communication with one or more clients through client APIs 314. Exemplary clients include client migration 332, client assignment, 334, LC workflow 336, and agent notices 338. These clients are explained in further detail below.

The gateway 302 is also connected with one or more users through the gateway web app 318, which may be hosted for example on an intranet or the publicly available Internet.

The gateway 302 may be configured as one or more computers, such as network-connected servers, running special purpose software. In one embodiment, the gateway 302 may be "cloud-hosted", or in other words the code may be executed on one or more general-purpose computers which are connected to a publicly-available network. Such computers provide computer capability that can be rented. Cloud hosting reduces capital costs to the user and enables easy upscaling of processes as demand increases. Cloud hosted computing systems are commercially available.

An example embodiment of the gateway 302 will be described as being hosted on a commercial cloud service. It will be understood that these components could be implemented in an on-premise configuration as an alternative.

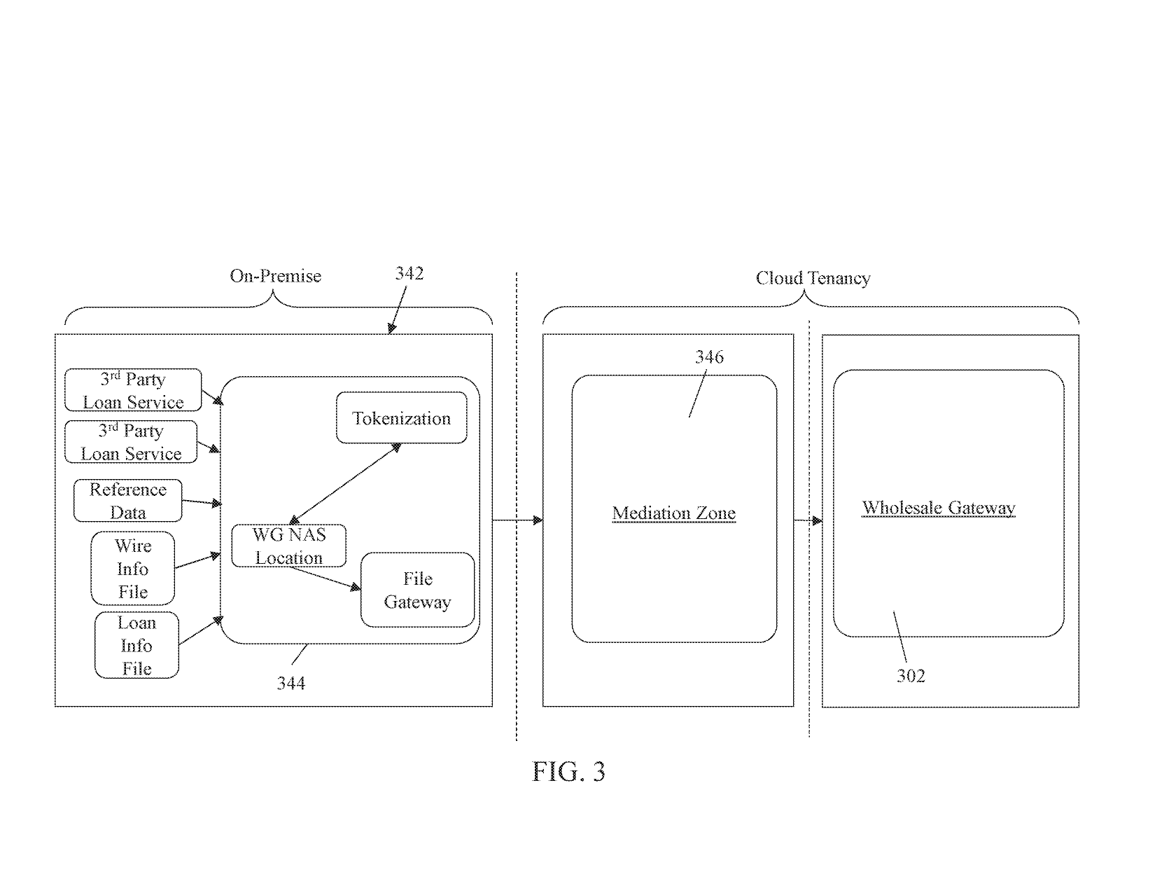

FIG. 3 illustrates an inbound file process for data which is transmitted to the gateway 302. As described above, a number of third-party services are in communication with an entity associated with the gateway 302, such as a company data center 342. Each of the third-party services transmits, over a network connection, data transactions into the data center 342 which includes network attached storage 344. The third-party services transmit data in real-time or near real time. A real-time system has been described as one which "controls an environment by receiving data, processing them, and returning the results sufficiently quickly to affect the environment at that time". The term "real-time" is used in process control and enterprise systems to mean "without significant delay". For example, certain transactions may be transmitted instantaneously. Others may be transmitted at a scheduled time such as hourly, every two hours, every four hours, or once per day.

It will be understood that most if not all the data transferred into and out of the gateway 302 is of a sensitive nature and its confidentiality and security must be protected. Accordingly, the data may be protected through tokenization. Tokenization is the process of substituting a sensitive data element with a non-sensitive equivalent, referred to as a token, that has no intrinsic or exploitable meaning or value. The token is a reference (i.e. identifier) that maps back to the sensitive data through a tokenization system. The mapping from original data to a token uses methods that render tokens infeasible to reverse in the absence of the tokenization system, for example using tokens created from random numbers. A one-way cryptographic function is used to convert the original data into tokens, making it difficult to recreate the original data without obtaining entry to the tokenization system's resources. Tokenization services are commercially available. The tokenization process permits the data to be safely transmitted and processed to a cloud hosted system.

The incoming data from the data center 342 is transmitted over a network connection to the gateway 302 which resides in a cloud tendency in this example. Initially, the incoming data is received into a mediation zone 346. In the mediation zone 346, various processes related to data security may be carried out, such as data filtering for sensitive information.

The data is passed from the mediation zone 346 into the gateway 302 where it is subjected to an extract, transform, load ("ETL") process. ETL is a three-phase computing process where data is extracted from an input source, transformed (including cleaning), and loaded into an output data container. The data can be collected from one or more sources and it can also be output to one or more destinations.

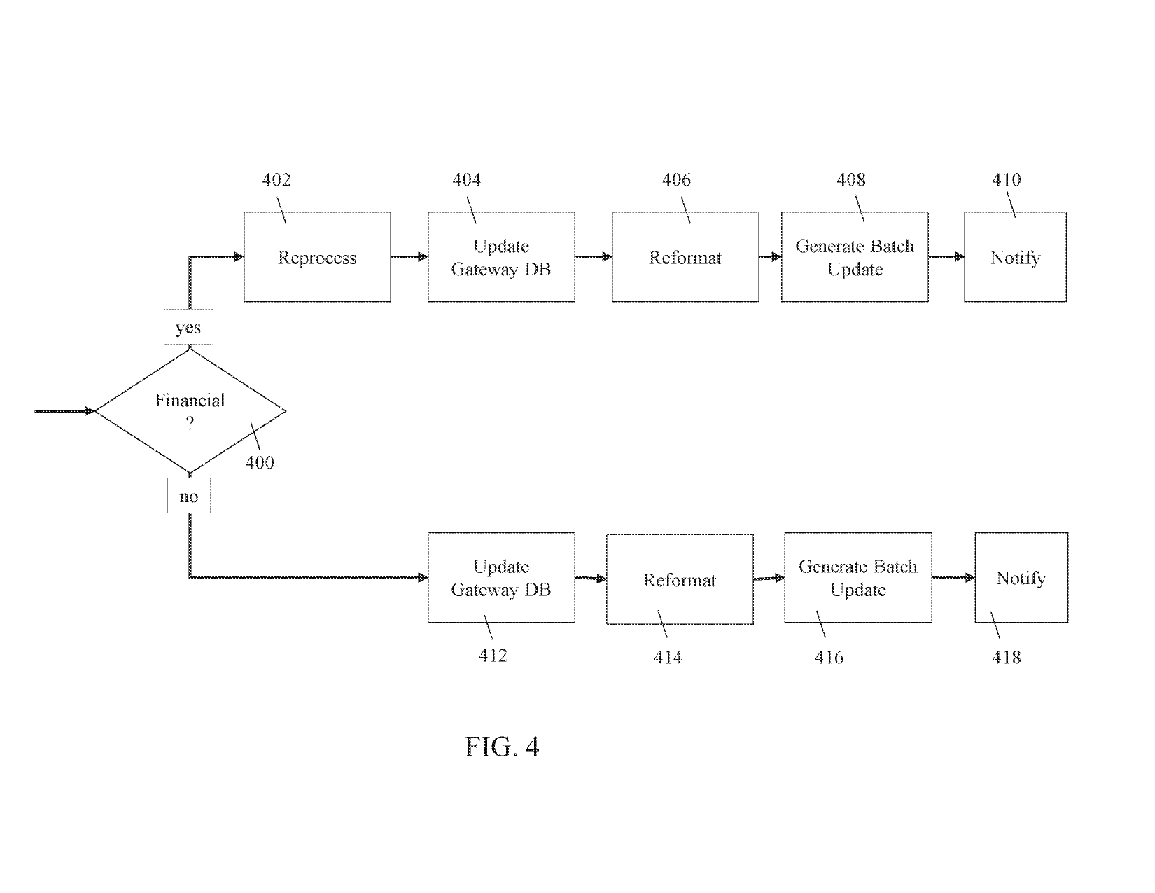

Upon completion of the ETL process, the data is ready for an internal batch process. This process is described with reference to FIG. 4. Initially, a distinction is made (block 400) between financial transactions and non-financial transactions. Financial transactions follow the process beginning at block 402. Initially, transactions are reprocessed as necessary for compatibility with the external database 330.

Reprocessing may include transaction matching logic. It will be understood that the third party systems identify financial transactions using a series of data fields. Nonlimiting examples of data fields include: account number, note number, loan amount, type of loan, loan hierarchy identification, and/or CUSIP number. These fields may or may not match fields used by the entity. In particular, primary key fields such as the entity's account number may be missing in the third-party data.

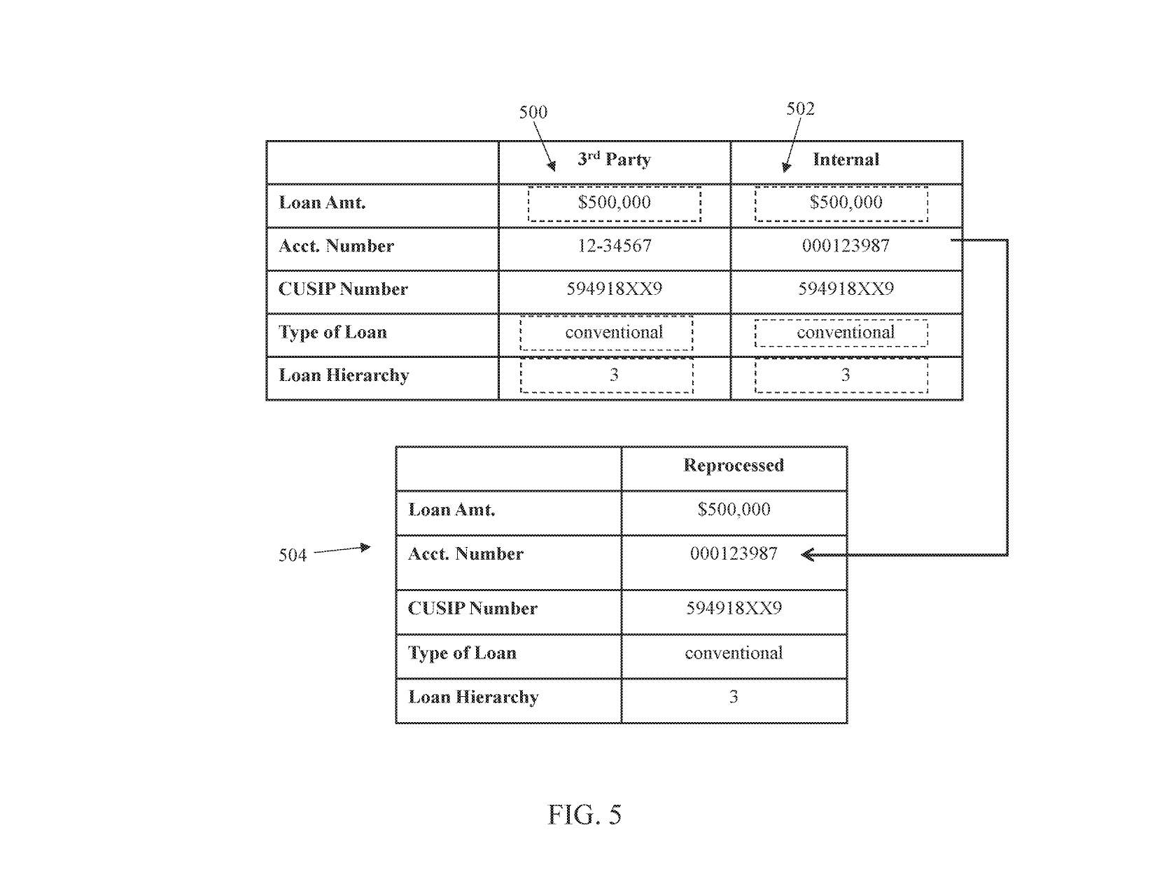

Accordingly, the matching logic includes the process of matching as many fields as possible in a transaction. Referring to FIG. 5, an exemplary transaction record is illustrated. The third-party data 500 indicates a loan amount of $500,000, along with an account number, a CUSIP number, type of loan, and a loan hierarchy. A search of internal records 502 in the database 308 shows no loans which have an internal account number matching the account number transmitted by the third party. In this case the internal account number is a primary key and is thus required to update the external database 330.

Matching may be performed by searching the internal database for data fields having values matching values in the respective third-party fields. In this example, there is a matching loan amount of $500,000, a matching CUSIP number, a matching loan type, and a matching loan hierarchy, indicated by the dashed rectangles.

It is noted that a CUSIP is a nine-character numeric or alphanumeric code that uniquely identifies a North American financial security for the purposes of facilitating clearing and settlement of trades. All CUSIP identifiers are fungible, which means that a unique CUSIP identifier for each individual security stays the same, regardless of the exchange where the shares were purchased or venue on which the shares were traded.

Based on the number of matching fields, there is an acceptable certainty that this transaction is applicable to the loan with the internal account number 000123987. Accordingly, prior to further processing, the transaction data will be rewritten with the internal account number, maintaining the values in the other fields. A reprocessed record 504 is shown.

Various criteria may be used to establish acceptable certainty of a matching record. In one example, a minimum number of matching fields may be required. For example, if at least three fields matching each record, this may be acceptable.

In another example, one or more fields may be assigned higher priority. For example, a matching CUSIP number may be sufficient to establish a matching record in combination with a smaller number of other matching fields. Yet another example one or more fields may be assigned primary priority. For example, a matching CUSIP number alone may be sufficient to establish a matching record.

Subsequent to reprocessing, the transaction may be used to update the gateway database 308 (block 404, FIG. 4). For example, if the transaction is a loan payment, the payment may be recorded, and appropriately applied to the interest and/or principal of the loan in the database 308.

Next, (block 406) the database update is then reformatted as required for a batch update of the external database 330.

Finally, (block 408) the reformatted update is transmitted as a batch update to the external database 330. This update is transmitted at a scheduled time, for example once per day.

Optionally, a notification (e.g., email, SMS message, etc.) may be transmitted over a network connection to appropriate personnel to confirm that the database update has been completed. See block 410.

Non-financial transactions follow the process beginning at block 412. The change may be used to update the gateway database 308. For example, if the changes is the name of a loan officer responsible for a matter, the name may be recorded. The database update is then reformatted as required for a batch update of the external database 330, block 414. Finally, the reformatted update is transmitted is a batch update to the external database 330, block 416. Optionally, a notification (e.g., email, SMS message, etc.) may be transmitted over a network connection to appropriate personnel to confirm that the database update has been completed, block 418.

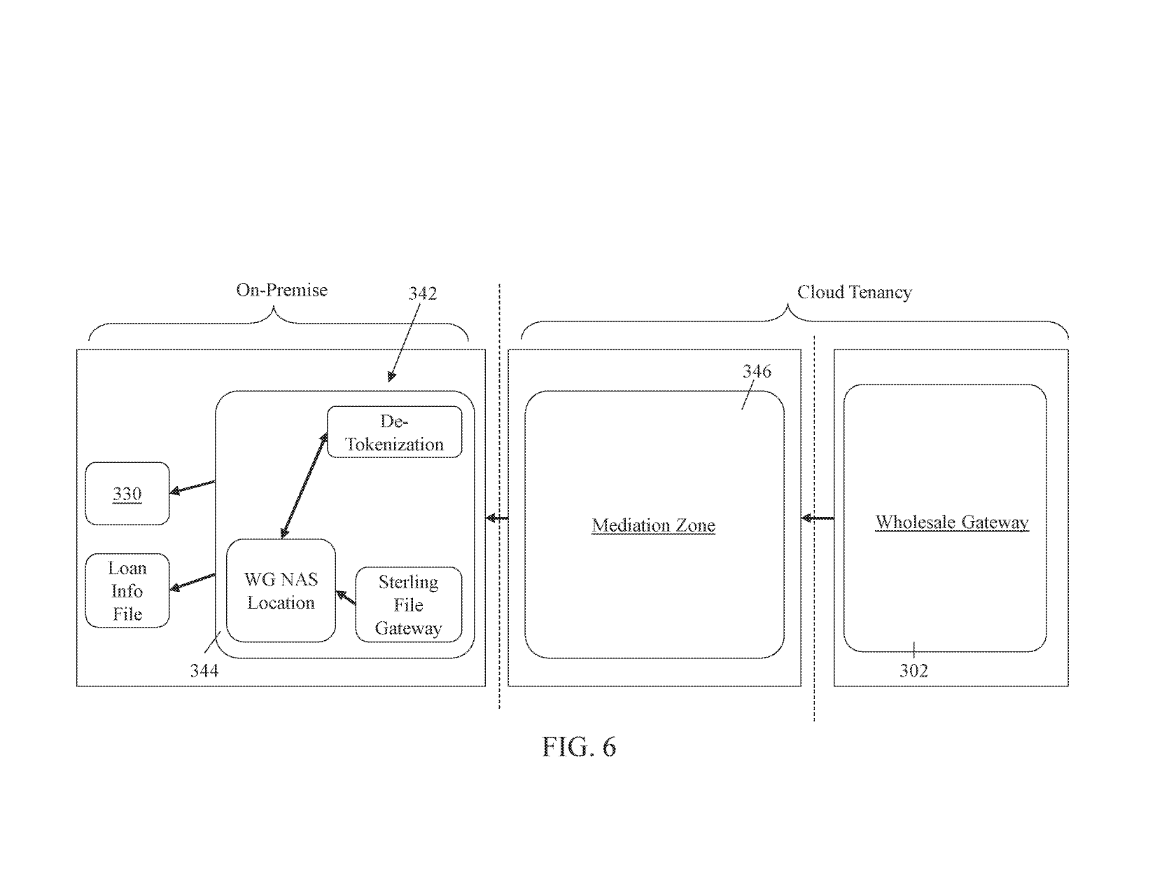

The batch updates to the external database 330 described above pass out of the gateway 302 through a outbound file process. FIG. 6 illustrates an outbound file process. The outbound data first passes back through the mediation zone 346. From there it is transmitted to the data center 342. At this stage the data is de-tokenized and stored in the network attached storage 344. Subsequently, the data can be transmitted to the third-party services, and the external database can be updated for the batch update process. The batch update may be a scheduled process, such as once per day.

Referring back to FIG. 1, the gateway client APIs 314 provide a functional connection to the clients 304.

The clients are programs or services that transfer data over a real-time or near real-time connection and incorporate a user interface such as a graphical user interface. They are not configured to make edits directly to the external database 330. On example is the client migration client 332. This would typically be used to make changes other than financial transactions. For example, name or address changes could be entered through the client migration client 332.

Another example is the client assignment client 334. This would typically be used to make organization-level changes other than financial transactions. For example, if a loan officer leaves the organization, a large number of loan records may need to have their assigned loan officer changed.

Another example is the LC workflow client 336. In this context, "LC" stands for letters of credit. This client would typically be used to make changes to the terms of existing loan records, such as extending the maturity date of existing loans.

Another example is agent notices 338. This comprises financial transaction data which originates as facsimile-machine transmitted data that is subjected to an optical character recognition (OCR) process.

In the prior art, information and transactions required manual data entry into the external database 330. More specifically, data entry required the creation of a spreadsheet file or comma separated value (CSV) file which would then be passed to the external database 330 in a batch process. In the present system, data from the clients is passed directly to the gateway client APIs 314. Subsequently, the changes are written to the gateway database 308 and then passed through the gateway backend process 310 so that they can be posted to the external database 330 following the batch process.

An application programming interface (API) is a connection between computers or between computer programs. It is a type of software interface, offering a service to other pieces of software. In contrast to a user interface, which connects a computer to a person, an application programming interface connects computers or pieces of software to each other. It is not intended to be used directly by a person (the end user) other than a computer programmer who is incorporating it into software. The calls that make up the API are also known as subroutines, methods, requests, or endpoints. The gateway client APIs are operable to receive data directly from the clients and make updates to the gateway database 308.

Referring back to FIG. 1, the gateway 302 may include web app 318. The web app 318 may be hosted on an intranet or the publicly available Internet. It provides a user-accessible interface for entering changes to the external database 330. It is connected to the gateway database 308 through gateway backend APIs 316. Similar to the client gateway APIs 314, data from the web app 318 is passed directly to the backend APIs 316. Subsequently, the changes are written to the gateway database 308 and then passed through the gateway backend process 310 so that they can be posted to the external database 330 following the batch process.

The systems and methods disclosed herein reflect an improvement in the functioning of a computer or an improvement to other technology or a technical field by reducing or eliminating manual processing required in the prior art to update databases. They further reduce processing time and resources required by using matching logic to ensure that data records can be handled via straight through processing.

Aspects of the present invention are described herein with reference to flowchart illustrations and/or block diagrams of computer-implemented methods and computing systems according to embodiments of the invention. It will be understood that each block of the flowchart illustrations and/or block diagrams, and combinations of blocks in the flowchart illustrations and/or block diagrams, can be implemented by computer readable program instructions that may be provided to a processor of a general purpose computer, special purpose computer, or other programmable processing apparatus (the term “apparatus” includes systems and computer program products). The processor may execute the computer readable program instructions thereby creating a means for implementing the actions specified in the flowchart illustrations and/or block diagrams. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the actions specified in the flowchart illustrations and/or block diagrams. In particular, the computer readable program instructions may be used to produce a computer-implemented method by executing the instructions to implement the actions specified in the flowchart illustrations and/or block diagrams.

The computer program instructions may also be stored in a computer-readable memory that can direct a computer or other programmable data processing apparatus to function in a particular manner, such that the instructions stored in the computer readable memory produce an article of manufacture including instructions, which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions, which execute on the computer or other programmable apparatus, provide steps for implementing the functions/acts specified in the flowchart and/or block diagram block or blocks. Alternatively, computer program implemented steps or acts may be combined with operator or human implemented steps or acts in order to carry out an embodiment of the invention.

In the flowchart illustrations and/or block diagrams disclosed herein, each block in the flowchart/diagrams may represent a module, segment, or portion of instructions, which comprises one or more executable instructions for implementing the specified logical function(s). In some implementations, the functions noted in the blocks may occur out of the order noted in the Figures. For example, two blocks shown in succession may, in fact, be executed substantially concurrently, or the blocks may sometimes be executed in the reverse order, depending upon the functionality involved.

Computer program instructions are configured to carry out operations of the present invention and may be or may incorporate assembler instructions, instruction-set-architecture (ISA) instructions, machine instructions, machine dependent instructions, microcode, firmware instructions, state-setting data, source code, and/or object code written in any combination of one or more programming languages.

An application program may be deployed by providing computer infrastructure operable to perform one or more embodiments disclosed herein by integrating computer readable code into a computing system thereby performing the computer-implemented methods disclosed herein.

Although various computing environments are described above, these are only examples that can be used to incorporate and use one or more embodiments. Many variations are possible.

The terminology used herein is for the purpose of describing particular embodiments only and is not intended to be limiting of the invention. As used herein, the singular forms "a", "an" and "the" are intended to include the plural forms as well, unless the context clearly indicates otherwise. It will be further understood that the terms "comprise" (and any form of comprise, such as "comprises" and "comprising"), "have" (and any form of have, such as "has" and "having"), "include" (and any form of include, such as "includes" and "including"), and "contain" (and any form contain, such as "contains" and "containing") are open-ended linking verbs. As a result, a method or device that "comprises", "has", "includes" or "contains" one or more steps or elements possesses those one or more steps or elements, but is not limited to possessing only those one or more steps or elements. Likewise, a step of a method or an element of a device that "comprises", "has", "includes" or "contains" one or more features possesses those one or more features, but is not limited to possessing only those one or more features. Furthermore, a device or structure that is configured in a certain way is configured in at least that way, but may also be configured in ways that are not listed.

The corresponding structures, materials, acts, and equivalents of all means or step plus function elements in the claims below, if any, are intended to include any structure, material, or act for performing the f unction in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of one or more aspects of the invention and the practical application, and to enable others of ordinary skill in the art to understand one or more aspects of the invention for various embodiments with various modifications as are suited to the particular use contemplated.

What is claimed is:

1. A computer-implemented method for updating a database, comprising:
receiving real-time or near real-time data;
passing the real-time data through an extract, transform, load process;
executing transaction matching logic on the real-time data to generate matched data;
entering the substance of a record change based on the matched data into a first database;
performing a backend process converting the record change to a batch process; and
executing a batch update of a second database.

2. The method of claim 1 wherein the transition matching logic, the record change, and the back end process are performed on one or more cloud-hosted computer servers.

3. The method of claim 2, wherein the real-time or near real-time data is tokenized before being transferred to the one or more cloud-hosted computer servers.

4. The method of claim 3, wherein the real-time or near real-time data is de-tokenized before being transferred to the second database.

5. The method of claim 1, wherein the transaction matching logic includes:
receiving data formatted as a plurality of data fields relating to a transaction, wherein a data field required by the second database is missing;
matching the received data fields to corresponding data fields in records within the second database, according to predetermined criteria;
based on the matching, adding the missing field to the received data; and
storing the data with the added field as a reformatted record.

6. The method of claim 5, wherein the predetermined criteria includes matching of a minimum number of fields in a given record.

7. The method of claim 5, wherein the predetermined criteria includes matching of a primary priority field.

8. The method of claim 1, wherein the real-time or near real-time data is received at random intervals, and the batch update is performed at scheduled intervals.

9. The method of claim 8, where the scheduled interval is once per day.

10. The method of claim 1, wherein the real-time or near real-time data is received from a third party over a data network.

11. The method of claim 1, wherein the real-time or near real-time data represents a financial transaction.

12. The method of claim 11, wherein the financial transaction is a loan payment.

13. The method of claim 1, wherein the second database is stored on a mainframe computer.

14. The method of claim 1, wherein the real-time or near real-time data is received through an API.

15. The method of claim 1, wherein the API is a part of a gateway which also includes a gateway ETL pipeline component, a gateway database, and a gateway backend process component.

16. The method of claim 15 wherein the gateway is hosted on a cloud computing service.

17. The method of claim 1, further comprising:
receiving real-time or near real-time data from a client system, through a gateway client API;
entering the substance of a record change based on the real-time or near real-time data into a first database;
performing a backend process converting the record change to a batch process; and
executing a batch update of a second database.

18. The method of claim 1, further comprising:
receiving real-time or near real-time data from a web application, through a gateway backend API;
entering the substance of a record change based on the real-time or near real-time data into a first database;
performing a backend process converting the record change to a batch process; and
executing a batch update of a second database.

19. A computing system for updating a database, the system comprising:
at least one processor;
a communication interface communicatively coupled to the at least one processor; and
a memory device storing executable code that, when executed, causes the at least one processor to:
receive real-time or near real-time data;
pass the real-time or near real-time data through an extract, transform, load process;
execute transaction matching logic on the real-time data to generate matched data;
enter the substance of a record change based on the matched data into a first database;
perform a backend process converting the record change to a batch process; and
execute a batch update of a second database.

20. A non-transitory computer-readable storage medium, the computer-readable storage medium including instructions that when executed by a processor, cause the processor to:
receive real-time or near real-time data;
pass the real-time or near real-time data through an extract, transform, load process;
execute transaction matching logic on the real-time data to generate matched data;
enter the substance of a record change based on the matched data into a first database;
perform a backend process converting the record change to a batch process; and
execute a batch update of a second database.
